(19) United States
(12) Patent Application Publication
(10) Pub. No.: US 2021/0014956 A1
(43) Pub. Date: Jan. 14, 2021

(54) X-RAY GENERATOR AND X-RAY UTILIZATION SYSTEM

(71) Applicant: HAMAMATSU PHOTONICS K.K., Hamamatsu-shi, Shizuoka (JP)

(72) Inventors: Atsushi ISHII, Hamamatsu-shi, Shizuoka (JP); Tomoaki TANIZAWA, Hamamatsu-shi, Shizuoka (JP)

(73) Assignee: HAMAMATSU PHOTONICS K.K., Hamamatsu-shi, Shizuoka (JP)

(21) Appl. No.: 17/042,624

(22) PCT Filed: Feb. 18, 2019
(86) PCT No.: PCT/JP2019/005916

§ 371 Date: Sep. 28, 2020

(30) Foreign Application Priority Data
Apr. 12, 2018 (JP) 2018-076991

(51) Int. Cl. H05G 1/02

(52) U.S. Cl. CPC H05G 1/025

(57) ABSTRACT

An X-ray generator includes an X-ray tube, a blower fan having a motor and configured to provide the X-ray tube with air, a motor control unit configured to control a rotation speed of the motor, and a casing to which the X-ray tube and the blower fan are attached. The motor control unit shifts the rotation speed of the motor from a resonance frequency of a structure including the X-ray tube and the casing. According to this configuration, a resonance phenomenon caused by vibration generated by the motor is avoided. Therefore, influences of vibration on the X-ray tube are reduced. As a result, the X-ray generator can be operated in a highly stable manner.

### TECHNICAL FIELD

The present disclosure relates to an X-ray generator, and another aspect thereof relates to an X-ray utilization system.

### BACKGROUND ART

An X-ray generator generates X-rays by causing electrons to collide with a target. Energy input to an X-ray tube is converted into energy of X-rays and heat energy. For example, as disclosed in Patent Literature 1, an X-ray generator includes a cooling device discharging heat energy emitted by an X-ray tube. Patent Literature 2 implies that operation of a cooling device has an influence when an X-ray generator performs irradiation with X-rays. For example, Patent Literature 3 discloses a technology for stably performing irradiation with X-rays by controlling a flow of oil serving as a heat medium.

### CITATION LIST

### Patent Literature

[Patent Literature 1] Japanese Unexamined Patent Publication No. H5-56958

[Patent Literature 2] Japanese Patent No. 2769434

[Patent Literature 3] Japanese Patent No. 5315914

### SUMMARY OF INVENTION

### Technical Problem

As the energy of X-rays emitted by an X-ray tube increases, the input energy also increases. As a result, heat energy increases as well. Here, there is a need to sufficiently discharge the heat energy generated from the X-ray tube by increasing the output of a cooling device. However, there is a possibility that influences of operation of the cooling device on the operation stability of an X-ray generator will also increase in accordance with increase of the output of the cooling device.

Here, objects of an aspect and another aspect of the present disclosure are to provide an X-ray generator and an X-ray utilization system which can be operated in a highly stable manner.

### Solution to Problem

According to an aspect of the present disclosure, there is provided an X-ray generator including an X-ray tube, a heat medium providing unit having a motor and configured to provide the X-ray tube with a heat medium, a motor control unit configured to control a rotation speed of the motor, and a device casing to which the X-ray tube and the heat medium providing unit are attached. The motor control unit shifts the rotation speed of the motor from a resonance frequency of a structure including the X-ray tube and the device casing.

In this X-ray generator, the temperature of the X-ray tube is controlled by the heat medium provided from the heat medium providing unit. Here, the heat medium providing unit has a motor. The rotation speed of the motor is controlled in accordance with a control signal provided from the motor control unit. The motor control unit shifts the rotation speed of the motor from the resonance frequency of the structure including the X-ray tube and the device casing. Consequently, a resonance phenomenon caused by vibration generated by the motor is avoided. Therefore, influences of vibration on the X-ray tube are reduced. As a result, the X-ray generator can be operated in a highly stable manner.

The X-ray generator may further include an X-ray control unit configured to control an intensity of X-rays output from the X-ray tube. The motor control unit may control the rotation speed of the motor on the basis of the intensity of X-rays. The quantity of heat generated by the X-ray tube is related to the intensity of X-rays. Here, efficient cooling can be performed by associating the rotation speed of the motor with the intensity of X-rays.

The motor control unit may increase the rotation speed of the motor as the intensity of X-rays increases, and may decrease the rotation speed of the motor as the intensity of X-rays decreases. When the intensity of X-rays increases, the quantity of heat emitted by the X-ray tube also increases. Here, the motor control unit raises the cooling performance by increasing the rotation speed of the motor. On the other hand, when the intensity of X-rays decreases, the quantity of heat emitted by the X-ray tube also decreases. Here, the motor control unit reduces the cooling performance by decreasing the rotation speed of the motor. Therefore, more efficient cooling can be performed.

The heat medium providing unit may include a fan rotated by the motor and may provide the X-ray tube with gas serving as the heat medium by using the fan. According to this configuration, the temperature of the X-ray tube can be controlled with a simple configuration.

The X-ray generator may further include an accommodation portion accommodating the X-ray tube and attached to the device casing. The accommodation portion may be disposed at a position away from the heat medium providing unit. According to this configuration, the heat medium providing unit and the X-ray tube are disposed at positions away from each other in the device casing. As a result, vibration generated by the heat medium providing unit is likely to be attenuated before it is transferred to the X-ray tube. Therefore, influences caused by operation of the heat medium providing unit on the X-ray tube is further curbed, and thus the X-ray generator can be operated in a highly stable manner.

The X-ray generator may further include a resin block unit including a power source providing the X-ray tube with a voltage. The accommodation portion may be attached to the device casing with the resin block unit therebetween. According to this configuration, vibration transferred to the device casing is transferred to the accommodation portion accommodating the X-ray tube via the resin block unit. As a result, vibration is attenuated while it is transferred to the resin block unit. Therefore, influences caused by operation of the heat medium providing unit on the X-ray tube are further curbed, and thus the X-ray generator can be operated in a highly stable manner.

According to another aspect of the present disclosure, there is provided an X-ray utilization system including an X-ray generator having an X-ray tube, a heat medium providing unit having a motor and configured to provide the X-ray tube with a heat medium, and a device casing to which the X-ray tube and the heat medium providing unit are attached; a motor control device configured to control a rotation speed of the motor; and a system casing to which the X-ray generator is attached. The motor control device shifts the rotation speed of the motor from a resonance frequency of a structure including the X-ray generator and the system casing.

In the X-ray utilization system, the motor control device shifts the rotation speed of the motor from the resonance frequency of the structure including the X-ray generator and the system casing. Consequently, this structure causes no resonance phenomenon. Therefore, influences caused by operation of a heat medium providing device on the entire X-ray utilization system are curbed. Therefore, the X-ray utilization system can be operated in a highly stable manner.

According to still another aspect of the present disclosure, there is provided an X-ray utilization system including an X-ray generator having an X-ray tube, a device casing to which the X-ray tube is attached, and a motor control unit; a heat medium providing device having a motor and configured to provide the X-ray tube with a heat medium; and a system casing to which the X-ray generator and the heat medium providing device are attached. The motor control unit shifts a rotation speed of the motor from a resonance frequency of a structure including the X-ray generator and the system casing.

With this X-ray utilization system as well, influences caused by operation of the heat medium providing device on the entire X-ray utilization system are curbed, and thus the X-ray utilization system can be operated in a highly stable manner.

According to further another aspect of the present disclosure, there is provided an X-ray utilization system including an X-ray generator having an X-ray tube and a device casing to which the X-ray tube is attached, a heat medium providing device having a motor and configured to provide the X-ray generator with a heat medium, a motor control device configured to control a rotation speed of the motor, and a system casing to which the X-ray generator and the heat medium providing device are attached. The motor control device shifts the rotation speed of the motor from a resonance frequency of a structure including the X-ray generator and the system casing.

With this X-ray utilization system as well, influences caused by operation of the heat medium providing device on the entire X-ray utilization system are curbed, and thus the X-ray utilization system can be operated in a highly stable manner.

### Advantageous Effects of Invention

According to the aspect and another aspect of the present disclosure, it is possible to provide an X-ray generator and an X-ray utilization system which can be operated in a highly stable manner.

### BRIEF DESCRIPTION OF DRAWINGS

FIG. 1 is a perspective view showing an appearance of an X-ray generator of a first embodiment.

FIG. 2 is a cross-sectional view along line II-II in FIG. 1.

FIG. 3 is a cross-sectional view of an upper wall portion along line III-III in FIG. 2.

FIG. 4 is a cross-sectional view showing a configuration of an X-ray tube.

FIG. 5 is a view showing the X-ray generator of the first embodiment.

FIG. 6 is a graph showing a relationship between a focal diameter and a rotation speed of a motor.

FIG. 7 is a view showing an X-ray inspection system of a second embodiment.

FIG. 8 is a flowchart for adjusting the relationship between the focal diameter and the rotation speed of the motor.

FIG. 9 is a view showing an example of fixing a power source device and the X-ray tube to a casing.

FIG. 10 is a view showing a configuration of an X-ray inspection system according to a first modification example.

FIG. 11 is a view showing a configuration of an X-ray inspection system according to a second modification example.

FIG. 12 is a view showing a configuration of an X-ray inspection system according to a third modification example.

### DESCRIPTION OF EMBODIMENTS

Hereinafter, embodiments of the present disclosure will be described in detail with reference to the drawings. The same reference signs are applied to parts which are the same or corresponding in each diagram, and duplicate description will be omitted. In addition, words indicating predetermined directions, such as “upward” and “downward”, are based on the states shown in the drawings and are used for the sake of convenience.

### First Embodiment

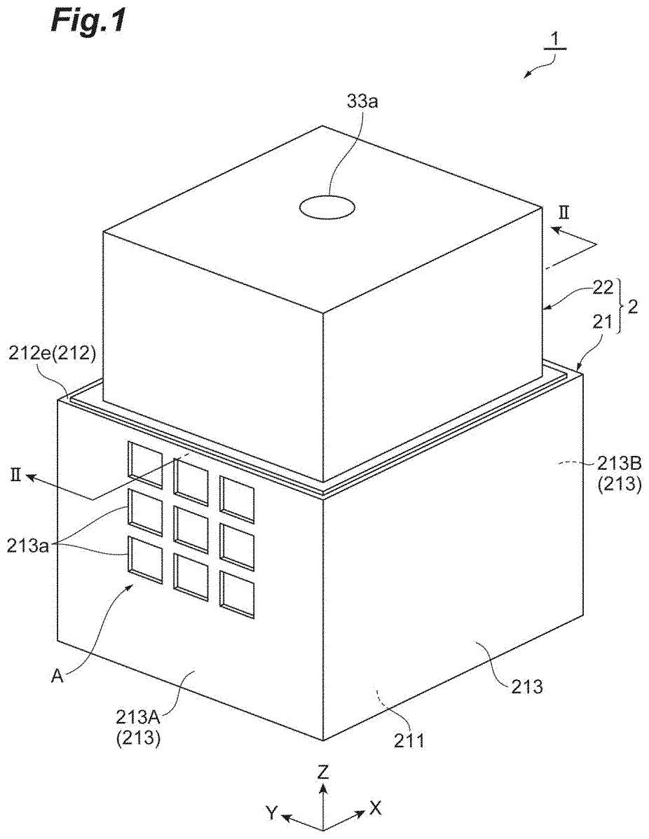

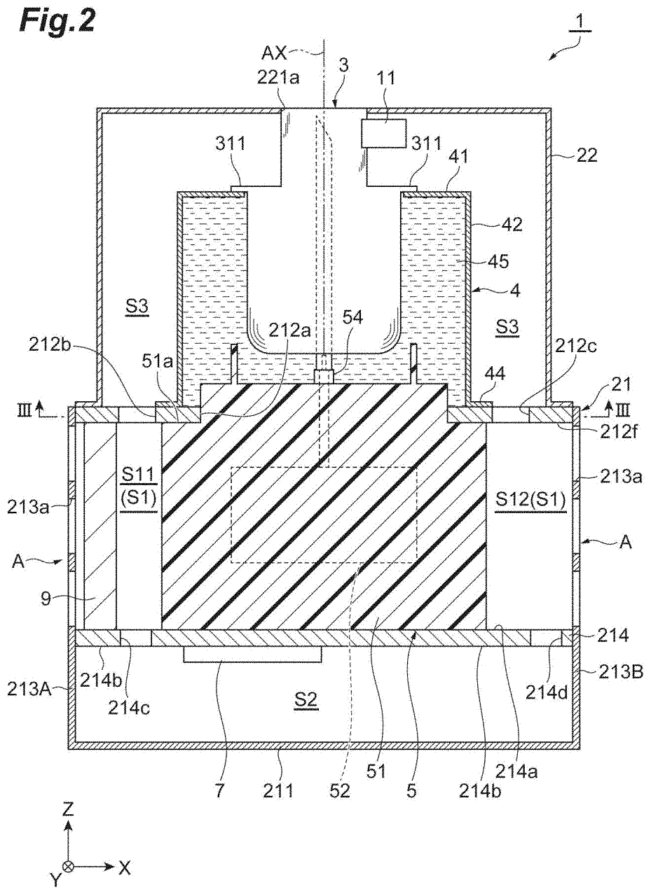

FIG. 1 is a perspective view showing an appearance of an X-ray generator according to an embodiment of the present disclosure. FIG. 2 is a cross-sectional view along line II-II in FIG. 1. For example, an X-ray generator 1 shown in FIGS. 1 and 2 is a micro-focus X-ray source used in a non-destructive X-ray test in which an internal structure of a test object is observed. The X-ray generator 1 has a casing 2 (device casing). Inside the casing 2, an X-ray tube 3 generating X-rays, an X-ray tube accommodation portion 4 accommodating a part of the X-ray tube 3, and a power source unit 5 supplying power to the X-ray tube 3 are mainly accommodated. The casing 2 has a first accommodation portion 21 and a second accommodation portion 22 (surrounding portion).

The first accommodation portion 21 is a part mainly accommodating the power source unit 5. The first accommodation portion 21 has a bottom wall portion 211, an upper wall portion 212, and side wall portions 213. Each of the bottom wall portion 211 and the upper wall portion 212 has a substantially square shape. Edge portions of the bottom wall portion 211 and edge portions of the upper wall portion 212 are joined to each other with four side wall portions 213 therebetween. Accordingly, the first accommodation portion 21 is formed to have a substantially rectangular parallelepiped shape. In the present embodiment, for the sake of convenience, a direction in which the bottom wall portion 211 and the upper wall portion 212 face each other will be defined as a Z direction, the bottom wall portion 211 side will be defined as a downward side, and the upper wall portion 212 side will be defined as an upward side. In addition, directions which are orthogonal to the Z direction and in which the side wall portions 213 facing each other face each other will be referred to as an X direction and a Y direction, respectively.

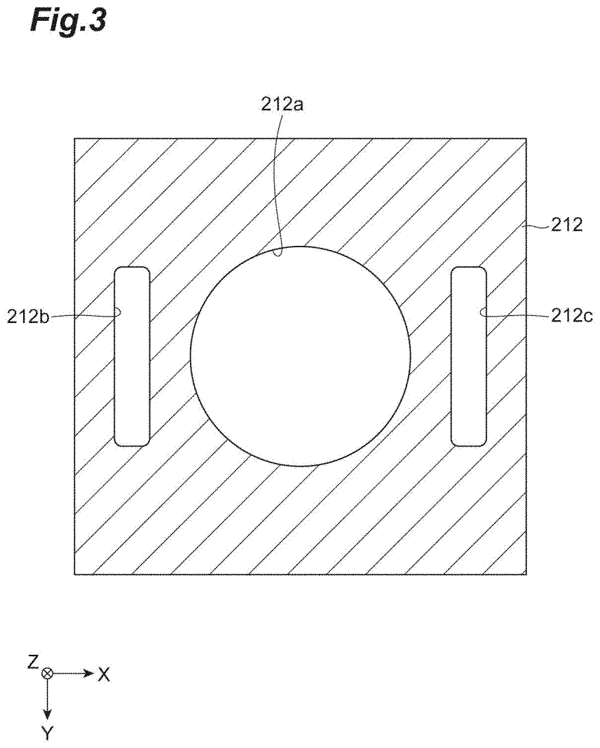

FIG. 3 is a cross-sectional view of the upper wall portion 212 viewed from below in FIG. 2. As shown in FIG. 3, in a central portion of the upper wall portion 212 viewed in the Z direction, a circular opening portion 212a is provided. In addition, in the upper wall portion 212, a pair of opening portions 212b and 212c (a first opening portion and a second opening portion) are provided at positions facing each other in the X direction with the opening portion 212a sandwiched therebetween. The opening portions 212b and 212c have a substantially rectangular shape having a longitudinal direction extending in the Y direction.

An intermediate wall portion 214 is provided between the bottom wall portion 211 and the upper wall portion 212 at a position away from both the bottom wall portion 211 and the upper wall portion 212. Due to such an intermediate wall portion 214, inside the first accommodation portion 21, a first accommodation space S1 surrounded by the upper wall portion 212, the side wall portions 213, and the intermediate wall portion 214; and a second accommodation space S2 surrounded by the bottom wall portion 211, the side wall portions 213, and the intermediate wall portion 214 are defined. In the first accommodation space S1, the power source unit 5 is fixed to an upper surface 214a of the intermediate wall portion 214. In the second accommodation space S2, a control circuit substrate 7 is attached to a lower surface 214b of the intermediate wall portion 214. A control circuit for controlling operation of each of the units and the portions (for example, the power source unit 5, a blower fan 9 (which will be described below), and an electron gun 11 (which will be described below)) of the X-ray generator 1 using various kinds of electronic components (not shown in the diagram) is constituted on the control circuit substrate 7.

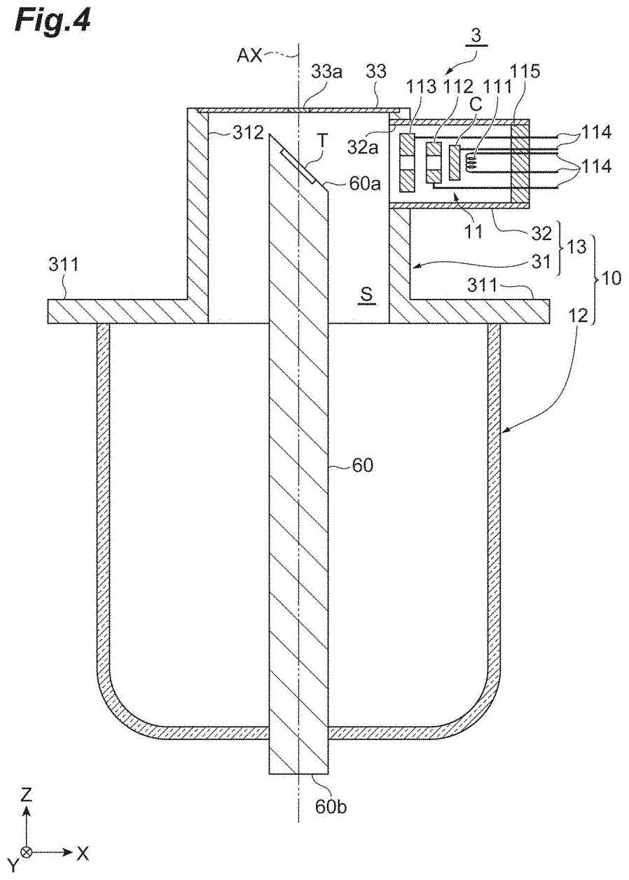

The second accommodation portion 22 is a part connected to an upper portion of the first accommodation portion 21 and accommodating the X-ray tube 3 and the X-ray tube accommodation portion 4. The second accommodation portion 22 surrounds the X-ray tube accommodation portion 4 when viewed in a direction along a tube axis AX of the X-ray tube 3 (a tube axis direction, that is the Z direction). The second accommodation portion 22 is fixed to an upper surface 212e of the upper wall portion 212 using a screw or the like. An opening portion 221a for exposing at least an X-ray emission window 33a of the X-ray tube 3 (refer to FIGS. 1 and 4) to the outside is provided in an upper portion of the second accommodation portion 22.

The X-ray tube accommodation portion 4 is formed of a metal having high heat conductivity (high heat dissipation). For example, regarding a material of the X-ray tube accommodation portion 4, it is preferable to use aluminum, iron, copper, an alloy including these, or the like. In the present embodiment, aluminum (or an alloy thereof) is used. The X-ray tube accommodation portion 4 has a tubular shape having openings on both ends of the X-ray tube 3 in the tube axis direction (Z direction). A tube axis of the X-ray tube accommodation portion 4 coincides with the tube axis AX of the X-ray tube 3. The X-ray tube accommodation portion 4 has a holding portion 41, a cylindrical portion 42, and a flange portion 44. The holding portion 41 is a part holding the X-ray tube 3 in a flange portion 311 using a fixing member (not shown in the diagram) and air-tightly seals the X-ray tube 3 together with an upper opening of the X-ray tube accommodation portion 4. The cylindrical portion 42 is a part connected to a lower end of the holding portion 41 and formed to have a cylindrical shape extending in the Z direction. The flange portion 44 is a part connected to an end portion of the cylindrical portion 42 and extending to the outward side when viewed in the Z direction. The flange portion 44 is air-tightly fixed to the upper surface 212e of the upper wall portion 212 at a position surrounding the opening portion 212a of the upper wall portion 212 when viewed in the Z direction. In the present embodiment, the flange portion 44 is thermally connected to the upper surface 212e of the upper wall portion 212 (comes into contact with the upper surface 212e of the upper wall portion 212 in a thermally conductive manner). Insulating oil 45 (electrically insulating liquid) is air-tightly enclosed inside the X-ray tube accommodation portion 4 (fills the inside of the X-ray tube accommodation portion 4).

The power source unit 5 is a part supplying power within a range of approximately several kV to several hundreds of kV to the X-ray tube 3. The power source unit 5 has an insulating block 51 (resin block unit) made of a solid epoxy resin, and an internal substrate 52 including a high-voltage generation circuit molded inside the insulating block 51. The insulating block 51 is formed to have a substantially rectangular parallelepiped shape. An upper surface central portion of the insulating block 51 penetrates the opening portion 212a of the upper wall portion 212 and protrudes. Meanwhile, an upper surface edge portion 51a of the insulating block 51 is air-tightly fixed to a lower surface 212f of the upper wall portion 212. A high-voltage power supply unit 54 including a cylindrical socket electrically connected to the internal substrate 52 is disposed on the upper surface central portion of the insulating block 51. The power source unit 5 is electrically connected to the X-ray tube 3 via the high-voltage power supply unit 54.

The outer diameter of a protrusion part of the insulating block 51 inserted through the opening portion 212a is the same as or slightly smaller than the inner diameter of the opening portion 212a.

In the present embodiment, a ventilation hole portion A is provided in each of side wall portions 213A and 213B facing each other in the X direction. A plurality of ventilation holes 213a causing the first accommodation space S1 and the outside to communicate with each other are provided in the ventilation hole portion A. The blower fan 9 (heat medium providing unit) serving as a cooling unit is provided on the inward side of the side wall portion 213A on one side. The blower fan 9 efficiently cools each of the units and the portions such as the X-ray tube accommodation portion 4, the power source unit 5, and the control circuit substrate 7 utilizing a space configuration formed inside the casing 2.

Specifically, the blower fan 9 generates cooling gas by taking in outside air through the ventilation hole portion A provided in the side wall portion 213A and blows this cooling gas to a space S11, of the first accommodation space 51, between the side wall portion 213A and the power source unit 5. The power source unit 5 is cooled by cooling gas blowing into the space S11.

A part of cooling gas circulating inside the space S11 flows into a surrounding space S3 defined between an outer surface of the X-ray tube accommodation portion 4 (an outer surface of the cylindrical portion 42) and an inner surface of the second accommodation portion 22 through the opening portion 212b of the upper wall portion 212. In addition, the surrounding space S3 is also defined between the X-ray tube 3 and the inner surface of the second accommodation portion 22. The surrounding space S3 is formed to encircle the X-ray tube accommodation portion 4 when viewed in the Z direction. Cooling gas which has flowed into the surrounding space S3 cools the X-ray tube 3 and the outer surface of the X-ray tube accommodation portion 4 by passing through the areas in the vicinities of the X-ray tube accommodation portion 4. Further, this cooling gas flows again into the first accommodation space S1 (a space S12, of the first accommodation space S1, between the side wall portion 213B and the power source unit 5) through the opening portion 212c of the upper wall portion 212 and is discharged to the outside through the ventilation hole portion A (exhaust portion) formed in the side wall portion 213B.

An opening portion 214c causing the space S11 and the second accommodation space S2 to communicate with each other and an opening portion 214d causing the space S12 and the second accommodation space S2 to communicate with each other are formed in the intermediate wall portion 214. Accordingly, a part of cooling gas circulating inside the space S11 flows into the second accommodation space S2 through the opening portion 214c of the intermediate wall portion 214. The control circuit substrate 7 is cooled due to cooling gas which has flowed into the second accommodation space S2. Further, this cooling gas flows again into the first accommodation space S1 (space S12) through the opening portion 214d of the intermediate wall portion 214 and is discharged to the outside through the ventilation hole portion A formed in the side wall portion 213B.

Next, a configuration of the X-ray tube 3 will be described. As shown in FIG. 4, the X-ray tube 3 is an X-ray tube which is referred to as a so-called reflection X-ray tube. The X-ray tube 3 includes a vacuum casing 10 serving as a vacuum envelope maintaining the inside in a vacuum state, the electron gun 11 serving as an electron generation unit, and a target T. For example, the electron gun 11 has a cathode C obtained by impregnating a base body made of a metal material or the like having a high-melting point with a substance easily emitting electrons. In addition, for example, the target T is a plate-shaped member made of a metal material having a high-melting point, such as tungsten. The center of the target T is positioned on the tube axis AX of the X-ray tube 3. The electron gun 11 and the target T are accommodated inside the vacuum casing 10, and X-rays are generated when electrons emitted from the electron gun 11 are incident on the target T. X-rays are generated radially from the target T (origin). In components of X-rays toward the X-ray emission window 33a side, X-rays drawn out to the outside through the X-ray emission window 33a are utilized as required X-rays.

The vacuum casing 10 is mainly constituted of an insulating valve 12 formed of an insulative material (for example, glass), and a metal portion 13 having the X-ray emission window 33a. The metal portion 13 has a main body portion 31 in which the target T (anode) is accommodated, and an electron gun accommodation portion 32 in which the electron gun 11 (cathode) is accommodated.

The main body portion 31 is formed to have a tubular shape and has an internal space S. A lid plate 33 having the X-ray emission window 33a is fixed to one end portion (outer end portion) of the main body portion 31. The material of the X-ray emission window 33a is a radiotranslucent material and is beryllium or aluminum, for example. The lid plate 33 closes one end side of the internal space S. The main body portion 31 has the flange portion 311 and a cylindrical portion 312. The flange portion 311 is provided on the outer circumference of the main body portion 31. The flange portion 311 is a part fixed to the holding portion 41 of the X-ray tube accommodation portion 4 described above. The cylindrical portion 312 is a part formed to have a cylindrical shape on one end portion side of the main body portion 31.

The electron gun accommodation portion 32 is formed to have a cylindrical shape and is fixed to a side portion of the main body portion 31 on one end portion side. The central axis of the main body portion 31 (that is, the tube axis AX of the X-ray tube 3) and the central axis of the electron gun accommodation portion 32 are substantially orthogonal to each other. The inside of the electron gun accommodation portion 32 communicates with the internal space S of the main body portion 31 through an opening 32a provided at an end portion of the electron gun accommodation portion 32 on the main body portion 31 side.

The electron gun 11 includes the cathode C, a heater 111, a first grid electrode 112, and a second grid electrode 113, and thereby the diameter of an electron beam generated by cooperation between these configurations can be reduced (micro-focusing can be performed). The cathode C, the heater 111, the first grid electrode 112, and the second grid electrode 113 are attached to a stem substrate 115 through a plurality of power supply pins 114 extending parallel to each other. Power is supplied to each of the cathode C, the heater 111, the first grid electrode 112, and the second grid electrode 113 from the outside through the corresponding power supply pin 114.

The insulating valve 12 is formed to have a substantially tubular shape. One end side of the insulating valve 12 is connected to the main body portion 31. In the insulating valve 12, a target support portion 60 in which the target T is fixed to a tip is held on the other end side thereof. For example, the target support portion 60 is formed of a copper material or the like in a columnar shape and extends in the Z direction. An inclined surface 60a inclining away from the electron gun 11 while it goes from the insulating valve 12 side toward the main body portion 31 side is formed on the tip side of the target support portion 60. The target T is embedded in an end portion of the target support portion 60 in a manner of being flush with the inclined surface 60a.

A base end portion 60b of the target support portion 60 protrudes to the outward side beyond the lower end portion of the insulating valve 12 and is connected to the high-voltage power supply unit 54 of the power source unit 5 (refer to FIG. 2). In the present embodiment, the vacuum casing 10 (metal portion 13) has a ground potential, and the high-voltage power supply unit 54 supplies a high positive voltage to the target support portion 60. However, a form of applying a voltage is not limited to the foregoing example.

[Control of Blower Fan]

The X-ray tube 3 included in the X-ray generator 1 releases a great part of energy incident based on the principle of generation of X-rays as heat. As a result, the quantity of generated heat increases as the output of X-rays is increased. As a result, due to heat of the X-ray tube 3, various influences such as deterioration in operation stability or deterioration in constituent members occur. Here, a configuration for efficiently discharging heat generated from the X-ray tube 3 becomes necessary. Regarding this configuration, the X-ray generator 1 in the present embodiment employs a forced air cooling method and has the blower fan 9 for providing air as a heat medium.

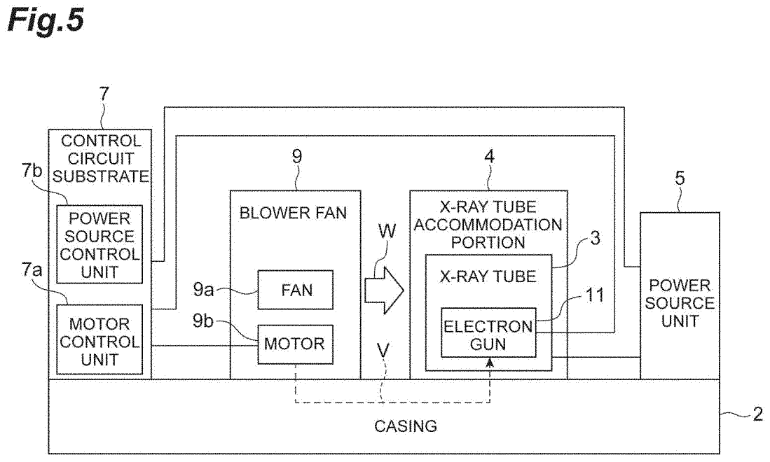

As shown in FIG. 5, the blower fan 9 has a fan 9a and a motor 9b. Since the motor 9b is a rotary machine, mechanical vibration may be generated during operation. This vibration V is transferred to the casing 2 in which the blower fan 9 is fixed. Various components constituting the X-ray generator 1 are attached to this casing 2. The X-ray tube 3 is also one of the components. Consequently, the vibration V generated by the motor 9b can also be transmitted to the X-ray tube 3.

In the X-ray tube 3, high positional accuracy is required when the target T is irradiated with electrons. When vibration is propagated to the X-ray tube 3, there is a possibility of occurrence of fluctuation in a relative positional relationship between the target T and the electron gun 11. As a result, variance occurs in size of an X-ray focus (which will hereafter be referred to as “a focal diameter”) or position of an X-ray focus (which will hereafter be referred to as “a focal position”), and thus obtained X-rays are not stable. As a result, for example, at the time of continuous image capturing, conditions for X-ray irradiation in a plurality of obtained X-ray images are no longer uniform so that the quality of image capturing deteriorates. In addition, the resolution of a captured image also deteriorates.

In addition, the X-ray generator 1 is a so-called micro-focus X-ray source in which the focuses of obtained X-rays are micronized to several tens of μm to several nm in order to improve the resolution of a captured image. In a micro-focus X-ray source, there are cases in which the focal diameter is controlled on the basis of an X-ray output. When the X-ray output is increased, the energy provided to the target T increases. At this time, if incident energy per unit area becomes excessively significant, the target T may be damaged. For this reason, from the viewpoint of preventing damage to the target T, there are cases in which control of uniformly maintaining the incident energy per unit area to the target T is performed. For example, when the X-ray output is increased, the focal diameter increases. In contrast, when the X-ray output is reduced, the focal diameter decreases. Hereinafter, the foregoing condition will be referred to as “this condition”.

Hereinafter, a case in which the X-ray generator 1 controls the blower fan 9 on the basis of an X-ray output under this condition will be described. The X-ray generator 1 has the control circuit substrate 7, and the control circuit substrate 7 includes a motor control unit 7a and a power source control unit 7b (X-ray control unit). The blower fan 9 is controlled by the motor control unit 7a included in the control circuit substrate 7. As first control, the motor control unit 7a increases or decreases a rotation speed of the motor 9b on the basis of an X-ray output. For example, when the X-ray output is decreased, the energy provided to the target T decreases, and thus the quantity of heat emitted by the X-ray tube 3 also decreases. That is, there is no need to have an excessive cooling ability, and the blower fan 9 need only provide gas (for example, air) necessary to discharge the quantity of heat emitted by the X-ray tube 3. Further, the amount of air provided to the X-ray tube 3 is controlled based on a rotation speed of the fan 9a. Therefore, when the X-ray output is decreased, the rotation speed of the motor 9b rotating the fan 9a decreases. In this condition, when the X-ray output is decreased, the focal diameter also decreases. That is, when the focal diameter is decreased, the rotation speed of the motor 9b decreases. In contrast, when the X-ray output is increased, the focal diameter also increases. That is, when the focal diameter is increased, the rotation speed of the motor 9b increases.

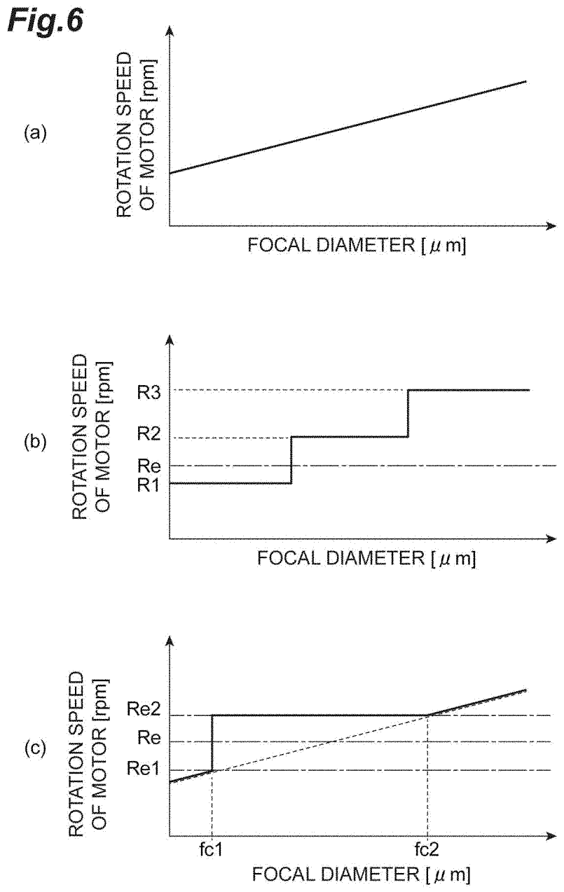

This relationship between the focal diameter and the rotation speed may be set to have a linear shape indicated by a linear function (refer to (a) of FIG. 6). In addition, the relationship between the focal diameter and the rotation speed may be set into a stepped shape (refer to (b) of FIG. 6). That is, the focal diameter is grouped into several ranges, and a predetermined rotation speed is set for each group. For example, when the focal diameter is within a range of 1 micrometer to 10 micrometers, the rotation speed is set to a first rotation speed (R1). When the focal diameter is within a range of 10 micrometers to 30 micrometers, the rotation speed is set to a second rotation speed (R2). When the focal diameter is 30 micrometers or larger, the rotation speed is set to a third rotation speed (R3). Each of the rotation speeds satisfies R1<R2<R3.

Here, when vibration is transferred from the blower fan 9 to the X-ray tube 3, vibration of the X-ray tube 3 may increase steeply under predetermined conditions. Specifically, when the blower fan 9 is assumed as a vibration source, and when the casing 2, the X-ray tube 3, and the like are assumed as a vibration system, if the frequency of vibration generated by the blower fan 9 coincides with a resonance frequency of the vibration system, a resonance phenomenon occurs. Since the amplitude increases due to this resonance phenomenon, variance in focal diameter or focal position may also increase. Here, the resonance frequency mentioned in the first embodiment indicates a frequency obtained by converting the rotation speed of the motor 9b at which the amplitude of displacement or acceleration caused by operation of the motor 9b becomes the largest in the X-ray tube 3. For example, such a resonance frequency may be obtained through structure analysis of the X-ray generator 1. In addition, the resonance frequency may be actually measured by performing a test such as a modal survey (resonance point survey).

Here, as second control, the motor control unit 7a shifts the frequency of vibration generated by the motor 9b from the resonance frequency. The frequency of vibration generated by the motor 9b is based on the rotation speed of the motor 9b. That is, the rotation speed of the motor 9b is controlled such that the frequency of vibration does not overlap the resonance frequency.

As shown in (c) of FIG. 6, a rotation speed (Re) corresponds to the resonance frequency. The rotation speed is set into a stepped shape in the vicinity of this rotation speed (Re). For example, the width of this step may be set utilizing a so-called half-value width. With a resonance peak interposed therebetween, there are two different frequencies (ω1 and ω2) at which vibration energy has a half value of the vibration energy when the rotation speed (Re) corresponds to the resonance frequency (that is, in a resonant state). The half-value width is a width from the frequency (ω1) to the frequency (ω2). Further, it is assumed that the frequency (ω1) corresponds to a rotation speed (Re1) and the frequency (ω2) corresponds to a rotation speed (Re2). Here, when the focal diameter is equal to or larger than a size (fc1) corresponding to the rotation speed (Re1) and is equal to or smaller than a size (fc2) corresponding to the rotation speed (Re2), the rotation speed is set to a constant value of (Re2). The rotation speed may have a constant value of (Re1).

The foregoing setting technique utilizing a half-value width is an exemplification, and a different setting technique may be used.

In addition, when the rotation speed is controlled into a stepped shape exemplified in (b) of FIG. 6, the first, second, and third rotation speeds are not caused to coincide with the rotation speed corresponding to the resonance frequency. That is, the part changing into a stepped shape and the line indicating the resonance frequency are caused to intersect each other.

[Effects]

In this X-ray generator 1, heat is discharged from the X-ray tube 3 due to air W provided from the blower fan 9. Here, the blower fan 9 has the motor 9b. The rotation speed of this motor 9b is controlled in accordance with a control signal provided from the motor control unit 7a. The motor control unit 7a shifts the rotation speed of the motor 9b from the resonance frequency of the structure including the X-ray tube 3 and the casing 2. Consequently, a resonance phenomenon caused by vibration generated by the motor 9b is avoided. Therefore, influences of vibration on the X-ray tube 3 are reduced. As a result, the X-ray generator 1 can be operated in a highly stable manner. Particularly, even at the same amplitude, the influences increase as the focal diameter is decreased, that is, the influences of vibration become remarkable as the focal diameter is decreased. Therefore, the present disclosure is particularly preferable for a micro-focus X-ray source as in the present embodiment.

The control circuit substrate 7 generates a control signal for controlling the intensity of X-rays output from the X-ray tube 3, and the motor control unit 7a included in the control circuit substrate 7 generates a control signal for controlling the rotation speed of the motor 9b on the basis of the intensity of X-rays. The quantity of heat generated by the X-ray tube 3 is related to the intensity of X-rays. Thus, efficient cooling can be performed by associating the rotation speed of the motor 9b with the intensity of X-rays.

The motor control unit 7a increases the rotation speed of the motor 9b as the intensity of X-rays increases, and the motor control unit 7a decreases the rotation speed of the motor 9b as the intensity of X-rays decreases. When the intensity of X-rays increases, the quantity of heat emitted by the X-ray tube 3 also increases. Here, the motor control unit 7a raises the cooling performance by increasing the rotation speed of the motor 9b. On the other hand, when the intensity of X-rays decreases, the quantity of heat emitted by the X-ray tube 3 also decreases. Here, the motor control unit 7a reduces the cooling performance by decreasing the rotation speed of the motor 9b. Therefore, more efficient cooling can be performed.

The blower fan 9 includes the fan 9a rotated by the motor 9b and provides the X-ray tube 3 with the air W serving as a heat medium by using the fan 9a. According to this configuration, the X-ray tube 3 can be cooled with a simple configuration. The heat medium is not limited to air and may be different gas (for example, nitrogen as inert gas). Moreover, the heat medium is not limited to gas and may be a liquid such as water. In this case, the motor 9b is used as a drive source of a water supplying/discharging mechanism for a liquid of a pump (chiller) or the like.

The X-ray generator 1 further includes the X-ray tube accommodation portion 4 accommodating the X-ray tube 3. The X-ray tube accommodation portion 4 is disposed at a position away from the blower fan 9. According to this configuration, the blower fan 9 and the X-ray tube 3 are disposed at positions away from each other in the casing 2. As a result, vibration generated by the blower fan 9 is likely to be attenuated before it is transferred to the X-ray tube 3. Therefore, influences caused by operation of the blower fan 9 on the X-ray tube 3 are further curbed, and thus the X-ray generator 1 can be operated in a highly stable manner.

The X-ray generator 1 further includes the insulating block 51 including the power source unit 5 providing the X-ray tube 3 with a voltage. The X-ray tube accommodation portion 4 is attached to the intermediate wall portion 214 of the casing 2 with the insulating block therebetween. According to this configuration, vibration transferred to the intermediate wall portion 214 is transferred to the X-ray tube accommodation portion 4 via the insulating block 51. As a result, vibration is attenuated while it is transferred to the insulating block 51. Therefore, influences caused by operation of the blower fan 9 on the X-ray tube 3 are further curbed, and thus the X-ray generator 1 can be operated in a highly stable manner.

### Second Embodiment

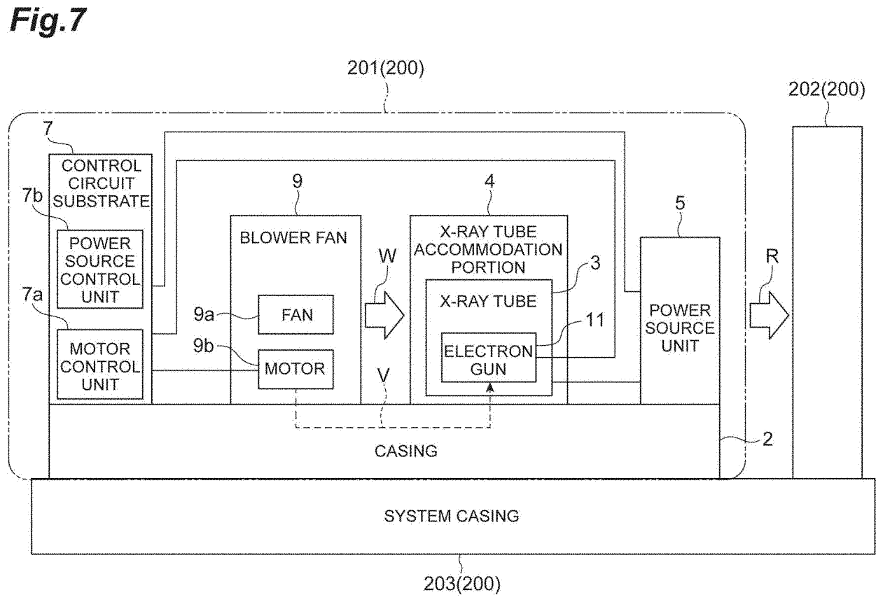

The X-ray generator 1 is utilized in an X-ray inspection system or the like utilizing X-rays. That is, the X-ray generator 1 may be used as a constituent element of an X-ray inspection system instead of being used by itself alone. As shown in FIG. 7, an X-ray inspection system 200 (X-ray utilization system) has an X-ray generator 201, an inspection device 202, and a system casing 203. The X-ray generator 201 provides the inspection device 202 with X-rays R. The inspection device 202 performs various kinds of inspection utilizing the X-rays R. Further, the X-ray generator 201 and the inspection device 202 are attached to the common system casing 203.

There is a possibility that the resonance frequency in the X-ray tube 3 may vary due to the influences of mechanical characteristics of the system casing 203, fixing positions of the constituent elements with respect to the system casing 203, fixing structures of the constituent elements with respect to the system casing 203, or the like. Here, the resonance frequency mentioned in a second embodiment indicates a frequency obtained by converting the rotation speed of the motor 9b at which the amplitude of displacement or acceleration caused by operation of the motor 9b becomes the largest in the X-ray tube 3. Consequently, there may be a case in which an optimum form of controlling the motor 9b when the X-ray generator 201 is used alone is not necessarily optimum when the X-ray generator 201 is assembled in the X-ray inspection system 200.

Accordingly, the motor control unit 7a of the control circuit substrate 7 adjusts the relationship between the focal diameter and the rotation speed (which will hereinafter be referred to as “a control pattern”).

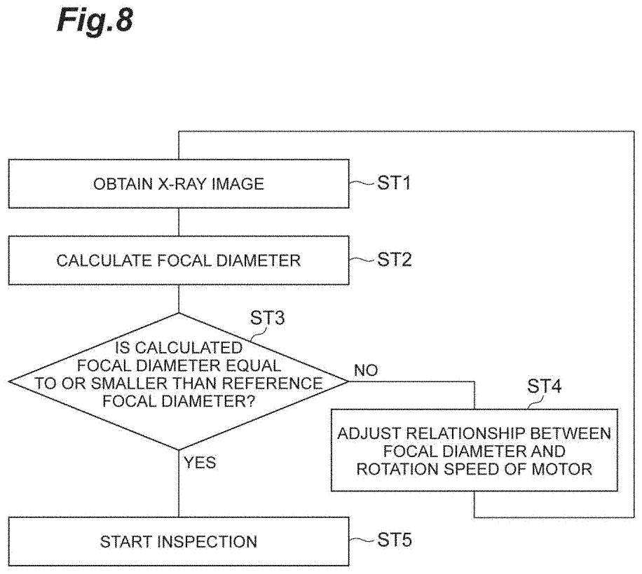

FIG. 8 is a flowchart showing an example of adjustment operation. Before this operation is performed, a control pattern in which the X-ray generator 201 can exhibit a desired performance alone is obtained. The aforementioned desired performance may include that X-rays having a desired focal diameter are emitted from the X-ray generator 201. That is, depending on the control pattern, in a postulated operation range, the focal diameter may be set to a reference value or smaller. Further, a measurement value of the actual focal diameter is obtained by controlling the focal diameter and the rotation speed on the basis of the control pattern. This measurement value is recorded as reference focal diameter data which is an actual value of the X-ray generator 1.

First, the X-ray generator 201 is assembled in the X-ray inspection system 200. Next, a reference X-ray image is obtained (Step ST1). Next, a focal diameter is obtained as calculated focal diameter data utilizing the X-ray image (Step ST2). For example, conversion of a focal diameter may be performed from the penumbra of the X-ray image. Next, the calculated focal diameter data and the reference focal diameter data are compared to each other (Step ST3). Specifically, it is determined whether or not the calculated focal diameter data is equal to or smaller than the reference focal diameter data. Further, when the calculated focal diameter data is equal to or smaller than the reference focal diameter data, it is possible to judge that a change in resonance frequency entailed by assembling with respect to the system does not impair the actual ability of the X-ray generator 1. Therefore, an actual inspection step is started utilizing the control pattern which has been set originally (Step ST5). On the other hand, when the calculated focal diameter data is equal to or larger than the reference focal diameter data, it is possible to judge that a change in resonance frequency entailed by assembling with respect to the system affects operation of the X-ray generator 1. Here, the relationship between the focal diameter and the rotation speed is adjusted (Step ST4). Further, processing is sequentially performed again from Step ST1, and the cycle is repeated until it is determined that the calculated focal diameter data is equal to or smaller than the reference focal diameter data in Step ST3.

According to this processing, in order to cope with a change in resonance frequency which may occur due to assembling with respect to the system, the X-ray generator 201 can be reset to a state in which a desired performance can be exhibited.

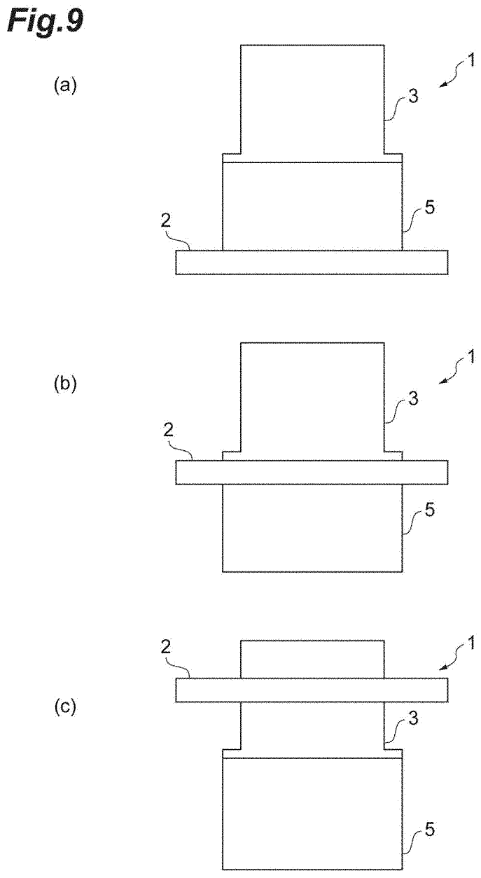

This adjustment flow can also be utilized when a control pattern is determined. As shown in FIG. 9, the X-ray generator 1 can employ several structures. Here, in order to facilitate the description, only the X-ray tube 3 and the power source unit 5 will be schematically shown as the X-ray generator 1. For example, there is a form of fixing the X-ray tube 3 to the casing 2 with the power source unit 5 therebetween (refer to (a) of FIG. 9). In addition, there is a form of fixing the X-ray tube 3 and the power source unit 5 to the casing 2 in the vicinity of a boundary between the X-ray tube 3 and the power source unit 5 (refer to (b) of FIG. 9). Moreover, there is a form of fixing the power source unit 5 to the casing 2 with the X-ray tube 3 therebetween (refer to (c) of FIG. 9). The difference between these structures may be manifested as a difference between the resonance frequencies. Moreover, there may be a case in which the resonance frequency varies depending on the fixing form even between the same structures. In other words, the resonance frequency of the X-ray generator 1 varies depending on the various factors.

Here, when the relationship between the focal diameter and the rotation speed is set, rotation speeds which can satisfy a requirement value for the focal diameter may be sequentially set based on the requirement value. In this case, the resonance frequency is not utilized directly, but the rotation speeds which can satisfy the requirement value avoid the resonance frequency as a result.

Hereinabove, the embodiments of the present disclosure have been described, but the present disclosure is not limited to the foregoing embodiments. For example, the X-ray tube 3 is a reflection X-ray tube drawing out X-rays in a direction different from an electron incidence direction with respect to a target, but it may be a transmission X-ray tube drawing out X-rays in the electron incidence direction with respect to a target (in which X-rays generated in a target are transmitted through the target itself and are drawn out through an X-ray emission window). In addition, the blower fan 9 is not limited to a fan blowing gas from the outside and may be a suctioning fan circulating gas by suctioning out gas from the inside to the outside. In addition, the blower fan 9 (heat medium providing unit) may have a function of circulating not only cold air (cooling gas) but also warm air as a heat medium. For example, the blower fan 9 may function as a temperature control unit of the X-ray tube 3 configured to be able to switch between a mode of blowing cold air and a mode of blowing warm air. In order to stabilize operation of the X-ray tube 3, there may be a case in which the temperature inside the X-ray tube accommodation portion 4 (that is, the temperature of the insulating oil 45) is desired to be raised to a certain temperature after the X-ray generator 1 has started. In such a case, the blower fan 9 is switched to blow warm air so that warm air circulates inside the surrounding space S3 and the temperature inside the X-ray tube accommodation portion 4 can be raised efficiently. As a result, the time taken until operation of the X-ray tube 3 is stabilized from the start of the X-ray generator 1 can be shortened. Moreover, the present disclosure can be subjected to various deformations within a range not departing from the gist thereof.

### First Modification Example

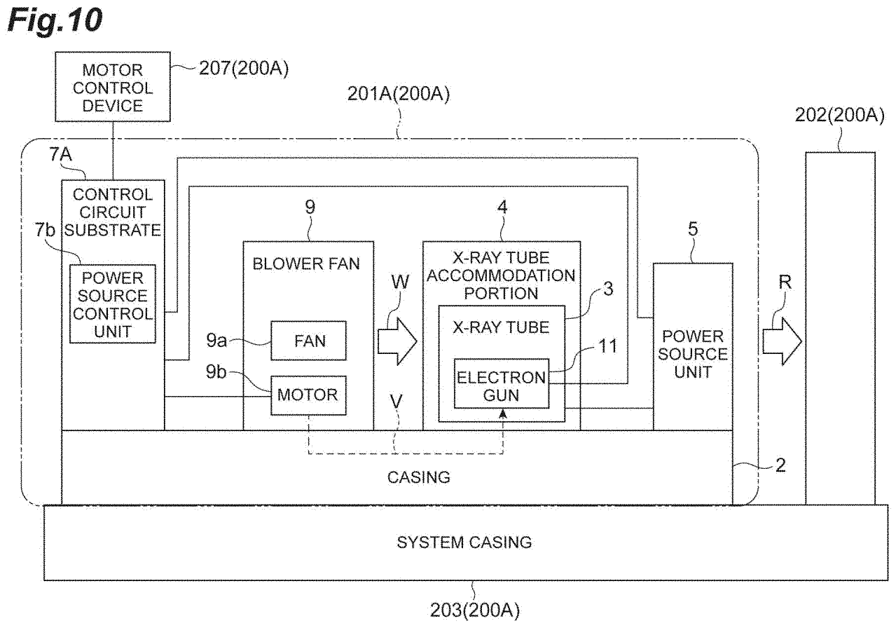

In the foregoing embodiments, the X-ray generator 201 includes the blower fan 9 and the motor control unit 7a. However, for example, as shown in FIG. 10, an X-ray generator 201A may not include the motor control unit 7a. An X-ray inspection system 200A may include a motor control device 207. In this case, the motor control device 207 receives data related to the focal diameter from a control circuit substrate 7A. Further, the motor control device 207 provides the control circuit substrate 7A with data related to the rotation speed of the motor 9b corresponding to this focal diameter. The motor control device 207 may directly transmit a control signal to the motor 9b without going through the control circuit substrate 7A. With this X-ray inspection system 200A as well, influences caused by operation of the blower fan 9 on the X-ray generator 201A are curbed. As a result, the X-ray inspection system 200A can exhibit a desired performance.

### Second Modification Example

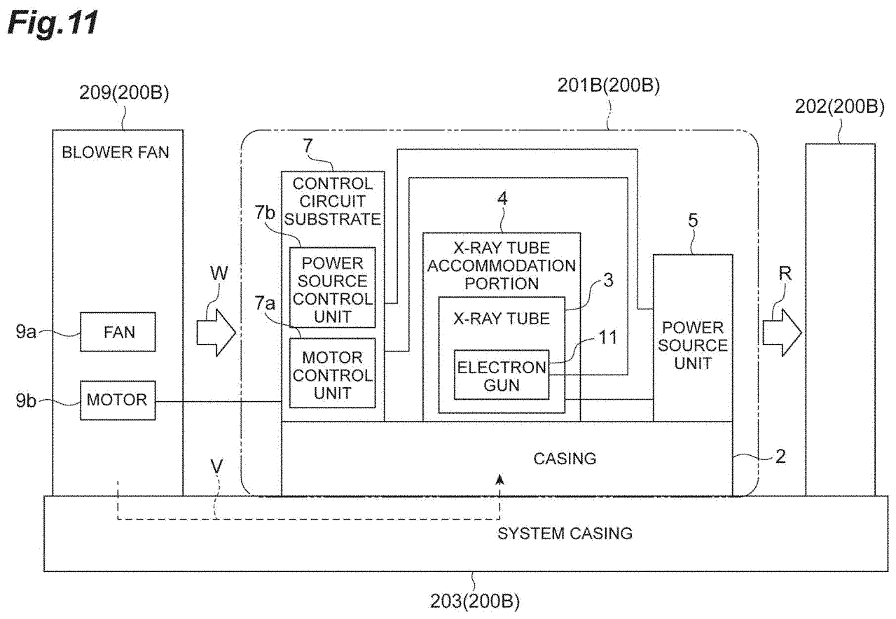

In addition, as shown in FIG. 11, an X-ray generator 201B may not include the blower fan 9. A blower fan 209 (heat medium providing device) may be a constituent element of an X-ray inspection system 200B. In this case, the motor control unit 7a outputs a control signal to the blower fan 209. With this X-ray inspection system 200B as well, influences caused by operation of the blower fan 209 on the X-ray generator 201B are curbed. As a result, the X-ray inspection system 200B can exhibit a desired performance.

### Third Modification Example

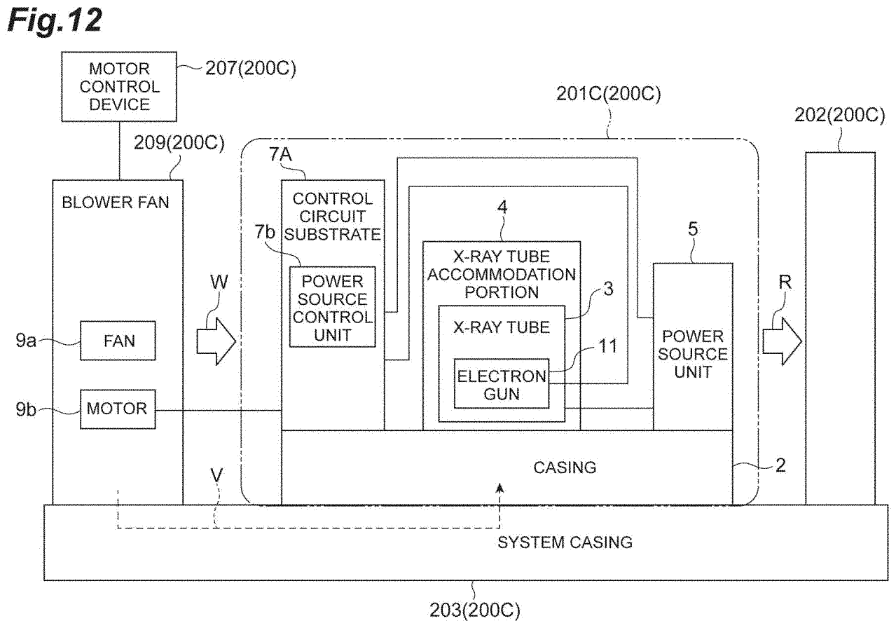

Moreover, as shown in FIG. 12, an X-ray generator 201C may not include the blower fan 9 and the motor control unit 7a. The blower fan 209 and the motor control device 207 may be a constituent element of an X-ray inspection system 200C. With this X-ray inspection system 200C as well, influences caused by operation of the blower fan 209 on the X-ray generator 201C are curbed. As a result, the X-ray inspection system 200C can exhibit a desired performance.

### REFERENCE SIGNS LIST

1 X-ray generator
2 Casing
3 X-ray tube
4 X-ray tube accommodation portion
5 Power source unit
7 Control circuit substrate
7a Motor control unit
9 Blower fan (heat medium providing unit)
21 First accommodation portion (accommodation portion)
22 Second accommodation portion (surrounding portion)
45 Insulating oil (insulating liquid)
212 Upper wall portion
212b Opening portion (first opening portion)
212c Opening portion (second opening portion)
AX Tube axis
S1 First accommodation space
S2 Second accommodation space
S3 Surrounding space

1. An X-ray generator comprising:
an X-ray tube;
a heat medium providing unit having a motor and configured to provide the X-ray tube with a heat medium;
a motor control unit configured to control a rotation speed of the motor; and
a device casing to which the X-ray tube and the heat medium providing unit are attached,
wherein the motor control unit is configured to shift the rotation speed of the motor from a resonance frequency of a structure including the X-ray tube and the device casing.

2. The X-ray generator according to claim 1 further comprising:
an X-ray control unit configured to control an intensity of X-rays output from the X-ray tube,
wherein the motor control unit is configured to control the rotation speed of the motor on the basis of the intensity of X-rays.

3. The X-ray generator according to claim 2,
wherein the motor control unit is configured to increase the rotation speed of the motor as the intensity of X-rays increases, and decrease the rotation speed of the motor as the intensity of X-rays decreases.

4. The X-ray generator according to claim 1,
wherein the heat medium providing unit includes a fan rotated by the motor and provides the X-ray tube with gas serving as the heat medium by using the fan.

5. The X-ray generator according to claim 1 further comprising:
an accommodation portion that accommodates the X-ray tube and is attached to the device casing,
wherein the accommodation portion is disposed at a position away from the heat medium providing unit.

6. The X-ray generator according to claim 5 further comprising:
a resin block unit that includes a power source providing the X-ray tube with a voltage,
wherein the accommodation portion is attached to the device casing with the resin block unit therebetween.

7. An X-ray utilization system comprising:
an X-ray generator having an X-ray tube, a heat medium providing unit having a motor and configured to provide the X-ray tube with a heat medium, and a device casing to which the X-ray tube and the heat medium providing unit are attached;
a motor control device configured to control a rotation speed of the motor; and
a system casing to which the X-ray generator is attached,
wherein the motor control device is configured to shift the rotation speed of the motor from a resonance frequency of a structure including the X-ray generator and the system casing.

8. An X-ray utilization system comprising:
an X-ray generator having an X-ray tube, a device casing to which the X-ray tube is attached, and a motor control unit;
a heat medium providing device having a motor and configured to provide the X-ray tube with a heat medium; and
a system casing to which the X-ray generator and the heat medium providing device are attached,
wherein the motor control unit is configured to shift a rotation speed of the motor from a resonance frequency of a structure including the X-ray generator and the system casing.

9. An X-ray utilization system comprising:
an X-ray generator having an X-ray tube and a device casing to which the X-ray tube is attached;
a heat medium providing device having a motor and configured to provide the X-ray generator with a heat medium;
a motor control device configured to control a rotation speed of the motor; and
a system casing to which the X-ray generator and the heat medium providing device are attached,
wherein the motor control device is configured to shift the rotation speed of the motor from a resonance frequency of a structure including the X-ray generator and the system casing.
